(19) United States
(12) Patent Application Publication
(10) Pub. No.: US 2010/0195054 A1
(43) Pub. Date: Aug. 5, 2010

(54) Illuminated spinning animation device

(76) Inventor: Marcus Gant, Norwalk, CA (US)

Correspondence Address: CARR & ASSOCIATES, 103 N. CLARK DRIVE, LOS ANGELES, CA, 90048, US

(21) Appl. No.: 12/322,295

(22) Filed: Jan. 30, 2009

(51) Int. Cl. G03B 25/00; B60B 7/04; G03B 29/00

(52) U.S. Cl. 352/102; 301/37.25; 352/132

(57) ABSTRACT

A device for selectively illuminating images on an auto wheel cap/spinner in a strobe-like fashion in order simulate an animated phenakistoscope which may be resident within the wheel-well of said automobile or implemented in a stand alone furnishing or piece of jewelry/clothing accessory.

### FIELD OF THE INVENTION

The invention relates to an illuminated decorative animation device which may be used on an automobile wheel, a piece of jewelry/clothing accessory or as a stand alone, portable decorative furnishing/item. More particularly, the invention relates to a device for selectively illuminating images on a cap/spinner in a strobe-like fashion, in order to provide an animated phenakistoscope type effect.

### BACKGROUND OF THE INVENTION

The phenakistoscope (also spelled phenakistiscope) was an early animation device. One variant of the phenakistoscope was a spinning disc mounted vertically on a handle. Around the center of the disc a series of pictures was drawn corresponding to frames of the animation; around its circumference was a series of radial slits. The user would spin the disc and look through the moving slits at the disc's reflection in a mirror. The scanning of the slits across the reflected images kept them from simply blurring together, so that the user would see a rapid succession of images with the appearance of a motion picture (see also persistence of vision). Another variant had two discs, one with slits and one with pictures; this second version was slightly more unwieldy; but, it needed no mirror. Unfortunately, one limitation of the phenakistoscope is that it could only practically be viewed or used by one person at a time.

A zoetrope is another device that produces an illusion of action from a rapid succession of static pictures. It consists of a cylinder with slits cut vertically in the sides. Beneath the slits on the inner surface of the cylinder is a band which has either individual frames from a video/film or images from a set of sequenced drawings or photographs. As the cylinder spins the user looks through the slits at the pictures on the opposite side of the cylinder's interior. The scanning of the slits keeps the pictures from simply blurring together so that the user sees a rapid succession of images producing the illusion of motion, the equivalent of a motion picture. Unfortunately, cylindrical zoetropes have the property of causing the images to appear thinner than their actual sizes when viewed in motion through the slits.

Finally, the praxinoscope is an animation device and successor to the zoetrope. Like the zoetrope, it uses a strip of pictures placed around the inner surface of a spinning cylinder. The praxinoscope improves on the zoetrope by replacing its narrow viewing slits with an inner circle of mirrors, placed so that the reflections of the pictures appear more or less stationary in position as the wheel turns. Someone looking in the mirrors therefore sees a rapid succession of images, producing the illusion of motion, with a brighter and less distorted picture than the zoetrope.

Furthermore, it is known in the art to provide selective lighting to a spinning tire and/or wheel in order to illuminate the tire/wheel and make alpha-numeric or other graphical depictions visible as the wheel/tire spins—i.e. when the automobile is in motion. There are dozens of prior art devices designed to selectively illuminate the wheel/tire at select intervals in order to make alpha-numeric characters or other graphical depictions on said wheel/tire visible to the human eye when the auto is in motion. Using these devices, a timer and control mechanism will cause light to appear on the wheel/tire at set intervals, thereby illuminating the alpha-numeric characters or other graphical depictions, making them appear as though they are stationary and not moving at all.

By way of example, U.S. Pat. No. 6,641,041 issued to Olds et al. discloses an illumination system that periodically directs a short burst of bright light onto the tire/wheel of car such that certain indicia is made visible and appears stationary. The indicia can be any alpha-numeric or graphical characters positioned on a tire sidewall or they can be a unique design repeating on the wheel itself.

While this type of prior art device works well for displaying an inanimate word, phrase or image on the sidewall of a tire, it is not suitable for providing any type of animation. More specifically, the item being displayed appears in the same location all the time and never changes its appearance.

It is desirable to be able to display an alpha-numeric character or an image and to further create the illusion of animation, such that it appears as though the displayed item is moving and changing. It is further desirable to be able to implement such a device for use with an automobile, such that the device is affixed to a car wheel and operates when the car wheel/tire spins.

It is also known in the art to use automobile hubcap designs as decorative furnishings and/or jewelry/clothing accessory. Accordingly, it is also desirable to implement the device of the present invention in a piece of jewelry and/or a stand alone decorative furnishing/item having alpha-numeric characters or images which are selectively illuminated or displayed (made visible) thereby creating the illusion of animation, such that it appears as though the displayed alpha-numeric characters or images are moving and changing—i.e. in motion.

### SUMMARY OF THE INVENTION

The invention relates to a device for selectively illuminating images on an a cap/spinner in order to simulate an animated phenakistoscope—i.e. in order to create the illusion that the images are in motion. In a first preferred embodiment, the cap spinner is rotationally fastened to an automobile wheel. In alternate embodiments, the device of the present invention may be implemented as a stand alone decorative furnishing/item or it may be implemented in a piece of jewelry or fashion accessory.

In accordance with a preferred embodiment, a circular shaped cap/spinner is provided that has a number of graphical images disposed circumferentially on a front surface of said cap/spinner in an umbrella-like fashion. These images may be printed, painted or otherwise embossed on the front surface of said cap/spinner; or, the images may be formed on the surface in a 3-D fashion, jutting/extending outward therefrom. If formed in a 3-D fashion, the images are preferably made from plastic and/or a very lightweight metal. In a preferred embodiment, each of the images is nearly identical except that there are small changes in appearance (size and/or shape) and/or position and orientation, such that each image is a slight modification of the image appearing just before it (in a clockwise direction) about the cap/spinner.

The cap/spinner is preferably made of plastic, aluminum or another lightweight material and has a firm metallic circular outside/outer ring (which may or may not be reinforced). In a first preferred embodiment, the cap/spinner is designed to mount to a conventional automobile wheel using a wheel mount such that it fits within and cover the wheel well, much like a conventional hub cap. The wheel mount includes an integrated spindle and a bearing assembly which together permit the spinner/cap to spin freely. In alternate embodiments, where the device is stand alone and implemented as a decorative piece of furnishing and/or a piece of jewelry, then the size of the cap/spinner may vary.

In a preferred embodiment, a plurality of LEDs are positioned on the cap/spinner. These LEDs are preferably evenly positioned circumferentially about the outer circumference of the cap/spinner. Each of these LED's is electrically coupled together in a serial fashion and the entire “string” or series of LEDs is electrically coupled to a power source. In an embodiment where the device is used on an auto wheel, this power source may be the car battery or any other “live” wire within the vehicle. Alternatively, where the device is stand alone and implemented as a decorative piece of furnishing, the power source may be an internal battery or a power converter with a conventional plug for use in an a conventional wall outlet/socket. Similarly, where the device is implemented as a piece of jewelry, the power source may be an internal battery.

In a preferred embodiment, at least one magnetic reed switch is disposed about the outer circumference of the cap/spinner and is electrically coupled between the series of LEDs and the power source. Reed switches are electrical switches which are activated by application of a magnetic field. When this reed switch closes, the power source is actively connected to the series of LEDs, and they are each activated and illuminated. Oppositely, when the reed switch is open, the series of LEDs are not actively connected to the power source and will remain unlit and dark.

The invention further includes a circular shaped shudder which is coupled to the cap/spinner via a central nut and a bearing ring. More specifically, the circular shaped shudder is placed adjacent to and over (covering) the circular shaped cap/spinner. The two preferably share a common central rotational axis (the central nut is coupled to a spinner mount of the cap/spinner); but, the bearing ring allows the shudder to remain in a stationary position even though it is coupled to the cap/spinner via a common central rotational axis.

In a preferred embodiment, the shudder is formed of a clear or opaque material, such as glass or clear plastic, and covered on one side with a very lightweight translucent film cut into a circular pattern. Accordingly, in a preferred embodiment, the shudder can be seen through preferably only when sufficient light is reflected off of, or projected from an object behind the shudder. In an alternative embodiment, the shudder may include an integrated lens system which allows for selective focus and illumination of items behind the shudder at select intervals. In this embodiment, the lens system may use natural or ambient light or it may use the LEDs as described earlier herein. Finally, in a preferred embodiment, the shudder is flanked and surrounded at inner and outer circumferences by two metal rings (an inner ring and an outer ring). Alternatively, these rings may be formed of plastic or some other steady/firm material.

In a preferred embodiment, the inner ring forms a shudder mounting hole for coupling the shudder to the cap/spinner such that it is positioned directly in front of the cap/spinner, while the outer ring is formed about the outer circumference of the shudder in order to provide stability. In a preferred embodiment, a heavy weight is positioned at a base point of the outer metallic ring of the shudder in order to prevent the circular shaped shudder from rotating, spinning or otherwise moving.

Initially, each of the LEDs positioned on the cap/spinner is inactive and the reed switch is in an open state. As the cap/spinner begins to rotate, i.e. as it is driven by the vehicle wheel/auto, the cap/spinner rotates and magnetic fields from the magnets of the shudder come into proximity with the reed switch on the cap/spinner, causing the contacts of the reed switch to close, thus completing an electrical circuit and providing power to the LEDs. This causes each of the plurality of LEDs to activate and illuminate. In this way, each of the individual images disposed circumferentially about the circular shaped cap/spinner are then made visible through the translucent film of the shudder. As the cap/spinner continues to spin, these images will appear to move—providing an animation effect.

### DESCRIPTION OF THE DRAWINGS

FIG. 1, illustrates a front view of a circular shaped cap/spinner, in accordance with a first preferred embodiment of the present invention;

FIG. 2, illustrates a front view of a circular shaped shudder, in accordance with a first preferred embodiment of the present invention;

FIG. 3 illustrates an enlarged view front view of placement of the cap/spinner and shudder, relative to one another, in accordance with a preferred embodiment of the present invention;

FIGS. 4 and 5 illustrate a side view of an automotive wheel well showing assembly and placement of the cap/spinner and shudder, relative to the wheel well, in accordance with a preferred embodiment of the present invention; and

FIG. 6 illustrates a side view of a stand alone decorative device/furnishing showing assembly and placement of the cap/spinner and shudder, relative to each other, in accordance with a preferred embodiment of the present invention.

### DETAILED DESCRIPTION OF PREFERRED EMBODIMENTS

The invention includes a phenakistoscope type device for selectively illuminating graphical images which appear on a cap/spinner of said phenakistoscope device. Preferably, these graphical images are illuminated in a strobe-like fashion, in order to provide the illusion that these images are animated/moving.

In a preferred embodiment, the invention is comprised of two main elements: a circular shaped cap/spinner and a shudder. These two main elements are preferably coupled together along a common central axis in a movable/rotatable fashion, such that each may rotate independently about the central axis. The cap/spinner is preferably circular in shape and has a plurality of images arranged in an umbrella-like fashion about its front surface. At least one of these images has a corresponding LED/reed switch pair of devices disposed adjacent to the image along the outer circumference of the wheel cap/spinner. There are also a plurality of additional LEDs electrically coupled to the LED/reed switch pair and preferably disposed in a circular fashion about the cap/spinner. The number and size of these LEDs may vary depending upon any particular embodiment.

Similarly, the shudder is also circular in shape and has a plurality of magnets disposed about its outer circumference. It is preferably comprised of an opaque material such as clear glass or plastic and covered with a thin film on an exterior surface. The film is preferably opaque such that an individual cannot see anything more than a shadow on the other side of the film when looking through the shudder. In operation, the cap/spinner of the present invention begins to rotate in a circular fashion; and, as it does so, magnets on the shudder will come into proximity with the at least one LED/reed switch pair of the cap/spinner. When this occurs, all of the LEDs will light up, illuminating the graphic images located behind the shudder and resident on the front surface of the cap/spinner adjacent to these LEDs. Accordingly, in operation, as the LEDs selectively illuminate the graphic images, they become visible to the human eye on the other side of the thin opaque shudder.

In a preferred embodiment, the images may be printed, painted or otherwise embossed on the front surface of said wheel cap/spinner; or, the images may be formed on the surface in a 3-D fashion, jutting/extending outward therefrom. If formed in a 3-D fashion, the images are preferably made from plastic and/or a very lightweight metal. Additionally, in a preferred embodiment, each of the images is nearly identical except for a small change in shape, orientation and or position. Accordingly, when the invention is in operation, the images will appear to be moving/changing in position, shape and/or size, thereby creating the illusion of animation.

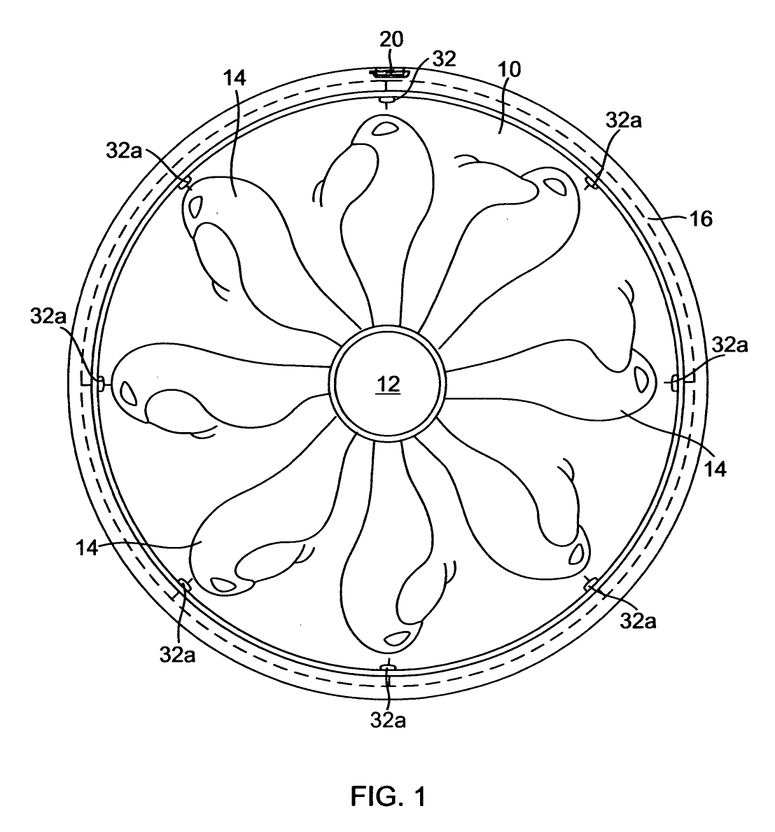

Referring to FIG. 1, there is shown a circular shaped cap/spinner 10, in accordance with a preferred embodiment of the present invention. The cap/spinner 10 is preferably formed in a circular shape and comprised of some type of light weight metal (i.e. plastic, aluminum, graphite, chrome, magnesium, or some other lightweight plastic/metal material). In a preferred embodiment, the cap/spinner has a central mounting hole 12 which is used to mount the cap/spinner such that it will spin, rotationally. As will be described further hereinafter, in a first preferred embodiment, the cap/spinner is mounted within the wheel well of a vehicle using a wheel mount, an integral spindle and a bearing assembly. The wheel mount includes a hub which passes through the central mounting hole of the cap/spinner. The cap/spinner is rotatably coupled to this hub such that the cap/spinner will rotate about this hub in a circular fashion. A retainer nut is used on an opposite side to hold the cap spinner onto the retainer nut.

As further shown in FIG. 1, the circular shaped cap/spinner also preferably has a number/plurality of images 14 arranged circumferentially about the front surface of the cap/spinner in an umbrella-like fashion. These images may be printed, painted or otherwise embossed on the front surface of said cap/spinner; or, the images may be formed on the surface in a 3-D fashion, jutting/extending outward therefrom. If formed in a 3-D fashion, the images are preferably made from plastic and/or a very lightweight metal. In a preferred embodiment, each of the images is nearly identical, except that there are small changes in appearance (size/orientation) and/or position, such that each image is a slight modification of the image appearing just before it (in a clockwise direction) about the wheel cap/spinner.

The cap/spinner preferably has a firm metallic circular outside/outer ring 16 which may be reinforced; and, in a first preferred embodiment, the cap/spinner is shaped and sized to fit entirely within the wheel well of a conventional vehicle. In alternative embodiments, the invention may be implemented as a decorative stand alone furnishing or a piece of jewelry, in which case the size of the cap/spinner may vary.

Referring still to FIG. 1, at least one magnetic reed switch 20 is disposed about the circumference of the wheel cap/spinner, preferably along the outer ring of the cap/spinner. This magnetic reed switch 20 is an electrical switch which is activated by an applied magnetic field. In a preferred embodiment the magnetic reed switch such that when a magnet comes within proximity of the switch, it will be activated. As is further shown in FIG. 1, this reed switch 20 is preferably electrically coupled to an adjacent and corresponding LED 32, thus creating an LED/reed switch pair. In a preferred embodiment, there are also a plurality of additional LEDs 32a positioned circumferentially about the outside/outer ring of the cap/spinner, with each LED in the plurality being positioned adjacent to a corresponding image. In this way, each of the individual images disposed circumferentially about the front surface of the circular shaped cap/spinner is flanked by a corresponding LED. These plurality of LEDs 32a are all electrically coupled together in series to the LED/reed switch pair such that when the reed switch is activated, not only is the LED immediately adjacent to the reed switch activated; but, all of of the LEDs are activated.

More specifically, in operation, when the reed switch is closed, its corresponding LED 32 and all of the other LEDs in the plurality, which are coupled together in a serial fashion, are activated. When the reed switch is open, its corresponding LED 32 and all of the other LEDs in the plurality, which are coupled together in a serial fashion, are inactive. When the LEDs are activated, they will direct light onto the adjacent images (i.e. the image appearing adjacent thereto on the front surface of the wheel cap/spinner).

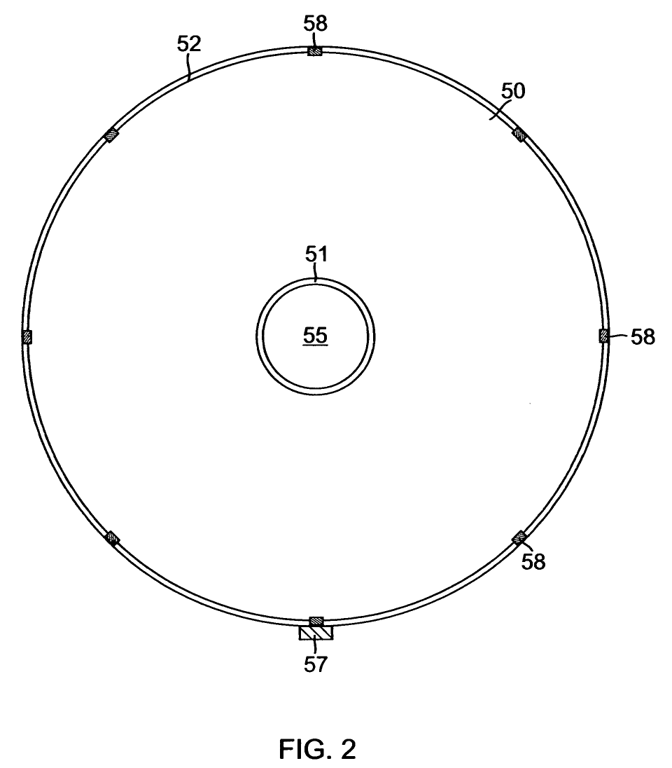

As explained earlier herein, the present invention further includes a shudder. FIG. 2, illustrates a shudder 50, in accordance with a preferred embodiment of the present invention. As shown in FIG. 2, the shudder is preferably formed of a very lightweight opaque material such as an opaque glass or plastic such that the human eye cannot see clearly through the shudder until and unless the other side is illuminated. The lightweight material is preferably covered on a first side with thin translucent film. The body of the shudder is preferably circular in form and contained within a pair of metal rings (inner 51 and outer rings 52). The inner ring 51 forms a shudder mounting hole 55 for mounting the shudder directly in front of the cap/spinner.

As is further shown in FIG. 2, the outer ring 52 is formed about the outer circumference of the shudder in order to provide stability. As is further shown in FIG. 2, a heavy weight 57 is positioned at a base point of the outer metallic ring of the shudder in order to prevent the circular shaped shudder from rotating or spinning when it is placed within the wheel well of the auto and mounted to the cylindrically shaped spinner mount.

Referring still to FIG. 2, the shudder is preferably configured with a plurality of magnets 58 which are preferably disposed evenly about the outer circumference of the shudder, along the outer ring. It is understood that the size and number of magnets used may vary from one embodiment to another. These magnets are designed to magnetically couple with and activate the magnetic reed switch on the wheel cap/spinner as the wheel cap/spinner rotates and they come into close proximity with the magnetic reed switch (as will be explained in greater detail further hereinafter). In an alternative embodiment, the shudder may include an integrated lens system which allows for selective focus and illumination of items behind the shudder at select intervals. In this embodiment, the lens system may use natural or ambient light or it may use the LEDs as described earlier herein.

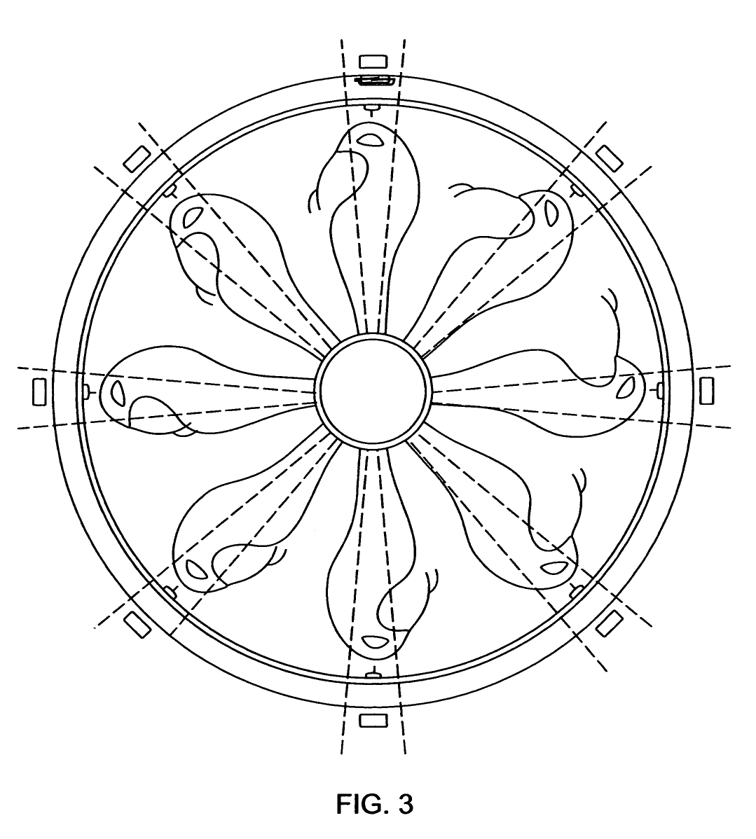

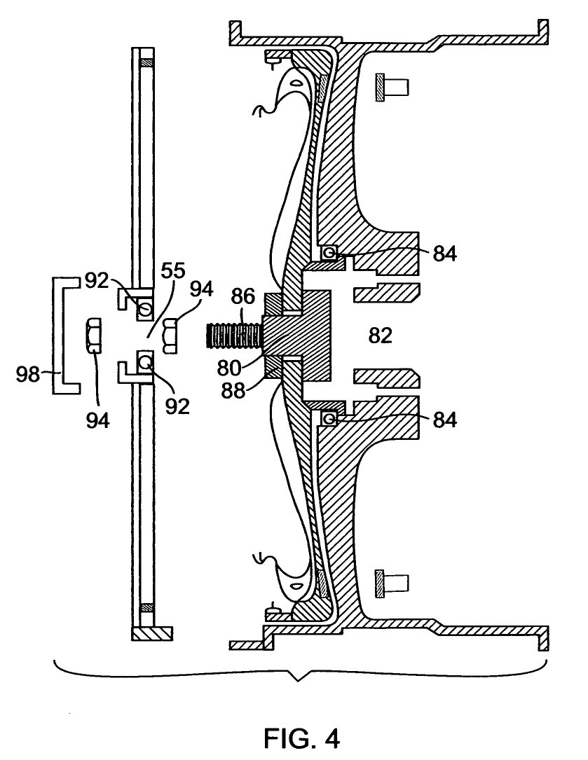

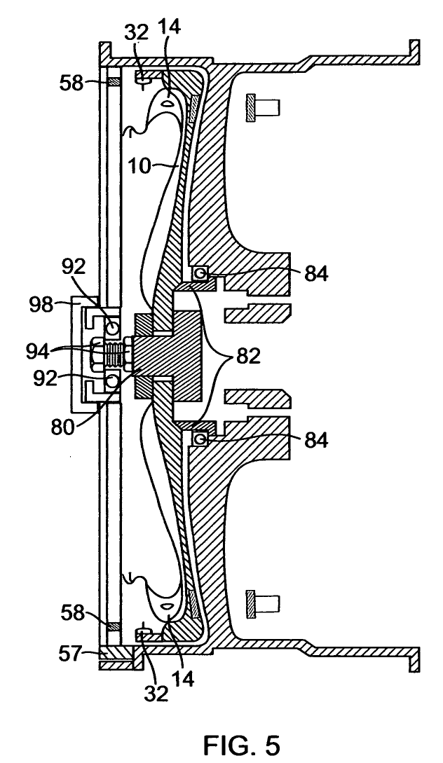

FIG. 3 illustrates an enlarged view front view showing placement of the cap/spinner and the shudder of the present invention; while FIGS. 4 and 5 illustrate a side view of an automotive wheel showing placement of the cap/spinner and shudder of the present invention, in accordance with one preferred embodiment. As is shown in FIGS. 4 and 5, the cap/spinner and the shudder are mounted to the wheel and/or axle in a parallel fashion such that the cap/spinner is mounted first and the shudder is then mounted adjacent and parallel thereto (appearing in front of the wheel cap/spinner).

As explained earlier herein, in such a preferred embodiment, the cap/spinner 10 and shudder are preferably designed to mount directly within the wheel well of an automobile using a spinner mount. FIG. 4 illustrates the component parts of such a spinner mount. As shown, the spinner mount includes a cap/spinner mount 80 having an integrated spindle 82 and a bearing assembly 84. The bearing assembly and spindle permit the cap/spinner mount 80 to rotate independently of the wheel. The cap/spinner mount also preferably includes a threaded hub 86 to which the shudder is connected. The cap/spinner will mount to the spinner mount 80 via the mounting hole 12 resident within the wheel cap spinner. It will preferably be held into place by using a spinner retaining nut 88.

Referring still to FIGS. 4 and 5, the shudder is preferably mounted directly in front of the cap/spinner. As shown in FIG. 4, the cap spinner preferably has a bearing ring 92 positioned inside the shudder mounting hole 55 about its circumference. This bearing ring 92 allows shudder to stay in position as the spinner mount 80 and cap/spinner rotate. In a preferred embodiment, the shudder 50 may be mounted onto the threaded hub 86 using a pair of retaining nuts 94.

In the embodiment illustrated in FIGS. 4 and 5, the inner ring 51 of the shudder 50 is designed to extend outward just above the surface of the thin film. In such a first embodiment, there may be an exterior cap/cover 98 design to fit securely and snuggle over the inner metal ring 51 of the shudder.

In a first preferred embodiment where the invention is mounted within the wheel well of an automobile, the cap/spinner will begin to initially spin from inertia caused by the wheel of the cars when the auto/car is in operation. More specifically, and continuing to refer to FIGS. 4 and 5, when the auto/car begins operations from rest, this will cause the cap/spinner to rotate in a circular fashion about its axis in whatever direction the wheel initially begins to spin. This causes the magnetic reed switch and plurality of LEDs to also spin and rotate about in a circumferentially or circular direction as well. As the reed switch comes into proximity with a magnet on the shudder, the switch is activated and a closed circuit forms, thereby activating the plurality of LEDs. When an LED is activated, it illuminates the graphical image adjacent to it—i.e. the image closest to the LED which appears on the front surface of the circular shaped wheel cap/spinner. In this way, each of the individual images disposed circumferentially about the front surface of the circular shaped wheel cap is positioned adjacent to an LED and when that LED is activated it will direct light onto any nearby image corresponding image.

In an embodiment where each of the images is a slight modification (i.e. where there are small changes in appearance, size, orientation and/or position), of the image appearing just before it in a clockwise direction about the wheel cap/spinner, this will result in a phenakistoscope effect and the images illuminated will appear to be animated as the auto/car moves and the wheel rotates. There is no limit to the types of graphical images that can be used for animation/illumination so the possibilities in providing a unique design within any one wheel/wheel well or limitless.

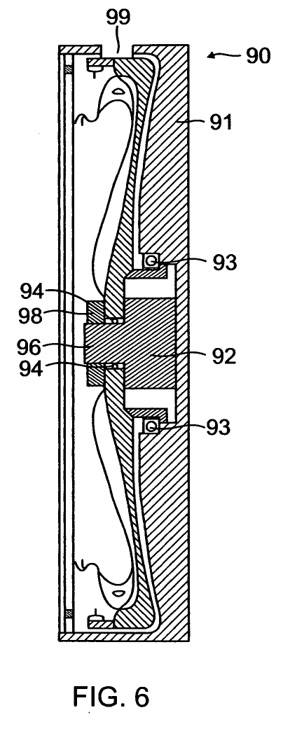

As explained earlier herein, the present invention may also be implemented in a stand alone decorative furnishing or as a piece of jewelry. FIG. 6 illustrates such an embodiment. In this embodiment, the cap/spinner is not mounted within a vehicle wheel well; but, is mounted within a casing 90. The casing preferably has a rear side 91 designed with a built in spinner mount 92 and first and second bearing rings 93, 94. The spinner mount and bearing rings will permit the cap/spinner to rotate freely. The spinner mount preferably includes a threaded hub 96 which is surrounded by the second bearing ring and upon which the cap/spinner is rotatably mounted. The cap/spinner is preferably held into place by using retaining nut 98.

In the embodiment illustrated in FIG. 6, the spinner is activated by hand through an aperture 99 preferably placed at the top of the casing 90. Alternatively, this opening may be placed on either side of the casing. In an alternative embodiment, the casing may be completely enclosed with no aperture and the cap spinner me electrically coupled to and activated by a motor. This motor may be any type of conventional drive motor known in the art so long as it generates sufficient power to operate the phenakistoscope (i.e. sufficient power to rotate the wheel cap/spinner). In a preferred embodiment, the motor may be powered by a battery or, alternatively, it may include its own power AC/DC power converter and be plugged into any conventional wall socket AC power source.

In summary, the present invention is a novel, inventive auto wheel device designed to provide effects similar to a conventional phenakistoscope and it addresses many of the shortcomings in the art. With respect to the above description, it is to be realized that variations in size, materials, shape, form, function, manner and use are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, while still falling within the scope of the invention. By way of example, and as described earlier herein, in at least one alternative embodiment, the shudder may include an integrated lens system which allows for selective focus and illumination of items behind the shudder at select intervals. In this embodiment, the shudder operates itself to either illuminate and/or blur the graphical images appearing on the cap/spinner, in which case the lens system may use natural or ambient light or it may use additional lighting—such as the LEDs as described earlier herein.

What I claim is:

1. A phenakistoscope type device for selectively illuminating images, said device comprising:
a circular shaped spinner having:
a plurality of images disposed circumferentially about a front surface of said spinner in an umbrella-like fashion;
at least one reed switch; and
a plurality of LEDS coupled together in serial fashion and disposed about the circumference of the spinner, wherein each LED is positioned nearby one of the images in the plurality and at least one LED in the plurality is configure to electrically couple with the at least one reed switch;
a circular shaped shutter positioned adjacent to said spinner and configured with a plurality of magnets disposed evenly about the outer circumference of the shudder;
wherein magnetic fields from the magnets cause the contacts of the reed switch to close when they are in proximity with said reed switch, thereby completing an electrical circuit and causing the plurality of LEDs to activate and illuminate each of the individual images disposed circumferentially about the spinner.

2. The device of 1, wherein each of the images on the spinner is nearly identical, except that there are small changes in appearance (size/orientation) and/or position, such that each image is a slight modification of the image appearing just before it (in a clockwise direction) about the wheel cap.

3. The device of claim 1, wherein the spinner may be manually activated to spin in a circular fashion.

4. The device of claim 1, further comprising:
an electric motor for driving said spinner and causing it to spin.

5. The device of claim 4, wherein the electric motor is electrically coupled to the battery of the automobile.

6 A device for selectively illuminating images within a wheel well of an automobile, said device comprising:
a circular shaped spinner resident within said wheel well and having:
a plurality of images disposed circumferentially about a front surface of said spinner in an umbrella-like fashion,
at least one reed switch electrically coupled to series of LEDs, said LEDs being disposed about the circumference of the spinner and adjacent to one of the images; and
a circular shaped shutter positioned adjacent to said spinner and configured with a plurality of magnets disposed evenly about the outer circumference of the shudder;
wherein magnetic fields from the magnets cause the contacts of the reed switch to close when they are in proximity with said reed switches, thereby completing an electrical circuit and causing the corresponding LEDs to activate and illuminate each of the individual images disposed circumferentially about the spinner.

7. The device of 6, wherein each of the images on the spinner is nearly identical, except that there are small changes in appearance (size/orientation) and/or position, such that each image is a slight modification of the image appearing just before it (in a clockwise direction) about the wheel cap.

8. The device of claim 3, further comprising:
a spinner mount for mounting the spinner and shudder to the axle of an automobile wheel.

9. An automobile wheel having a built in phenakistoscope comprised of:
a circular shaped wheel cap having a plurality of images disposed circumferentially about the wheel cap in an umbrella-like fashion, said wheel cap further including at least one reed switch electrically coupled to a plurality of LEDs arranged in series, said LEDs also being disposed about the circumference of the wheel cap adjacent to one of the images such that each of the individual images in the plurality is flanked by an LED; and
a circular shaped shutter positioned adjacent to said wheel cap and configured with a plurality of magnets disposed evenly about the outer circumference of the shudder;
wherein magnetic fields from the magnets in the shudder come into proximity with the reed switch on the wheel cap as the automobile wheel rotates, causing the contacts of the reed switch to close and complete an electrical circuit, and thereby causing the corresponding LEDs to activate and illuminate each of the individual images disposed circumferentially about the wheel cap.

10. The automobile wheel of claim 9, wherein each of the images on the wheel cap is nearly identical, except that there are small changes in appearance (size/orientation) and/or position, such that each image is a slight modification of the image appearing just before it (in a clockwise direction) about the wheel cap.

11. The automobile wheel of claim 4, further comprising:
a spinner mount for mounting the wheel cap and shudder to the axle of the automobile wheel.

12. A phenakistoscope type device for selectively illuminating images, said device comprising:
a circular shaped spinner having:
a plurality of images disposed circumferentially about a front surface of said spinner in an umbrella-like fashion;
at least one reed switch; and
a circular shaped shudder positioned adjacent to said spinner and having an integrated lens system which allows for selective focus and illumination of the plurality of images disposed about the front surface of the spinner as it rotates behind the shudder at select intervals.

13. The phenakistoscope of claim 12 wherein the circular shaped spinner also includes a plurality of LEDS coupled together in serial fashion and disposed about the circumference of the spinner, each LED being positioned nearby one of the images in the plurality and at least one LED in the plurality configured to electrically couple with the at least one reed switch.

14. The phenakistoscope of claim 13 wherein the circular shaped shutter is configured with a plurality of magnets disposed evenly about the outer circumference of the shudder, and further wherein magnetic fields from the magnets cause the contacts of the reed switch to close when they are in proximity with said reed switch, thereby completing an electrical circuit and causing the plurality of LEDs to activate and illuminate each of the individual images disposed circumferentially about the spinner.

15. The device of claim 14, wherein each of the images on the spinner is nearly identical, except that there are small changes in appearance (size/orientation) and/or position, such that each image is a slight modification of the image appearing just before it (in a clockwise direction) about the wheel cap.
